(19) United States
(12) Patent Application Publication
(10) Pub. No.: US 2012/0314796 A1
(43) Pub. Date: Dec. 13, 2012

(54) METHOD OF SIGNAL EXCHANGE, METHOD OF BIT-SEQUENCE TRANSMISSION, AND BATTERY PACK

(76) Inventors: Hitomi HORI, Sumoto-shi (JP); Hidetaka Arai, Minamiawaji-shi (JP); Kazuhiro Toyoda, Sumoto-shi (JP); Hiroyoshi Yamamoto, Sumoto-shi (JP)

(21) Appl. No.: 13/489,644

(22) Filed: Jun. 6, 2012

(30) Foreign Application Priority Data
Jun. 7, 2011 (JP) 2011-127469

(51) Int. Cl. H04L 27/00

(52) U.S. Cl. 375/295

(57) ABSTRACT

A first bit-sequence, which is to be transmitted from a control section to an authentication chip according to an encoding scheme that transmits each one and zero by a pulse with a width of 200 μsec and 100 μsec respectively, is converted to a second bit-sequence to be transmitted according to NRZ encoding. The converted second bit-sequence is stored in a register with the MSB of the second bit-sequence aligned in the MSB of the register. Timing to set the pulse width for transmission of a one or zero by NRZ encoding is performed repeatedly, and at the start of each timed interval, the signal transmission level output to the authentication chip is set corresponding to the value of the bit stored in the MSB of the register. After setting the signal transmission level, the register is shifted left one bit.

### BACKGROUND OF THE INVENTION

1. Field of the Invention

The present invention relates to a method of exchanging authentication signals with external electrical equipment in a battery pack provided with an authentication section, which performs battery pack authentication with the electrical equipment via a communication control section, to a method of transmitting bit-sequences from the communication control section to the authentication section, and to a battery pack.

2. Description of the Related Art

In recent years, operation of portable electrical devices (electrical equipment) by battery pack attachment has become commonplace, and battery pack capacity required by electrical equipment has only increased over time. There is a current trend to increasingly use high energy-density lithium-ion batteries as the rechargeable batteries that make up a battery pack. However, compared to other rechargeable batteries, lithium-ion batteries are expensive. Therefore, it is assumed that inexpensive non-standard (not guaranteed by the manufacturer) imitation and counterfeit battery packs will ultimately appear in the marketplace, and there is a high probability that the non-standard battery packs will be used without due consideration. Furthermore, it is easy to imagine the use of non-standard battery packs mistakenly verified as standard product.

Incidentally, of the different types of rechargeable batteries, lithium-ion batteries are particularly intolerant to use under conditions that exceed specifications such as over-charging and over-discharging. Accordingly, a lithium-ion battery pack is provided with internal protection circuitry such as an over-charge protection circuit and an over-discharge protection circuit. Using a battery pack protected by these types of protection circuits not only assures battery pack safety, but also secures safe operation of the electrical equipment connected with the battery pack.

In contrast, this type of protection circuitry is typically weak or simply not provided in (non-standard) battery packs that are not certified to set standards. Consequently, in the event of abnormal conditions such as over-charging or over-discharging, not only is there concern for battery pack failure or fire damage, but these conditions result in threatening the safety of electrical equipment connected with the non-standard battery pack.

Accordingly, technology has been disclosed that judges whether a battery pack is standard product or non-standard (authentic or counterfeit) by exchanging signals between the battery pack and electrical equipment connected with the battery pack where the input-output relation of the signals is not easily deciphered (refer to Japanese Patent No. 4097582).

Further, technology has been disclosed that does not stop at simply discerning counterfeit battery packs from authentic battery packs, but also verifies that the battery pack is genuine product (refer to Japanese Laid-Open Patent Publication 2007-282471). For example, the battery pack is provided with an authentication section that includes an authentication chip, and the battery pack is verified genuine by authentication attempts made between the externally connected electronic equipment (electrical equipment) and the authentication section.

### SUMMARY OF THE INVENTION

However, technology disclosed in JP 2007-2282471 connects a second communication line between the electronic equipment control circuit and the battery pack authentication chip that is separate from a first communication line that connects a charging circuit in the electronic equipment with the battery pack communication control circuit. This technology has the drawbacks that circuitry becomes complex and cost becomes high.

The present invention was developed reflecting on the situation described above. Thus, it is a primary object of the present invention to provide a method of signal exchange, method of bit-sequence transmission, and battery pack that can reduce the number of signal lines connected in a battery pack having authentication capability.

The method of signal exchange of the present invention is a method of exchanging authentication signals between external electrical equipment and an authentication section in a battery pack provided with a rechargeable battery, a communication control section that controls communication with electrical equipment that can charge and discharge the rechargeable battery, and an authentication section that performs battery pack authentication with the electrical equipment. The method is characterized by providing a serial communication line between the authentication section and the communication control section, and exchanging signals via the serial communication line and the communication control section.

The method of bit-sequence transmission of the present invention is a method of transmitting a first bit-sequence to the authentication section using the method of signal exchange described above, and in accordance with an encoding scheme that transmits zeros and ones via the communication control section with different pulse widths. The method is characterized by providing a register, converting the first bit-sequence to a second bit-sequence to be transmitted by non-return-to-zero (NRZ) encoding, and storing the converted second bit-sequence in the register. Further, when repeatedly timing pulse widths to transmit zeros and ones by NRZ encoding, the (voltage) level for serial communication line transmission is changed according to changes in the value of each bit read sequentially from the second bit-sequence stored in the register.

In the method of bit-sequence transmission of the present invention, the converted second bit-sequence is stored in the register in a manner that makes the lead-bit the most significant bit (MSB) (or the least significant bit [LSB]); when timing for transmission is started, the level transmitted by the serial communication line is changed depending on the value of the MSB (or LSB) stored in the register; and subsequently the register is shifted left (or right) by one bit.

In the method of bit-sequence transmission of the present invention, memory is provided, each one of a plurality of bit-sequences having a given number of bits to be transmitted by the encoding scheme is converted to a bit-sequence to be transmitted by NRZ encoding, and each of the plurality of bit-sequences and corresponding converted bit-sequences are stored and linked in memory. When the number of bits in the first bit-sequence exceeds the given number of bits, the first bit-sequence is segmented into bit-sequences having the given number of bits. Bit-sequences stored in memory and linked to each segmented bit-sequence are read-out, and the read-out bit-sequences are joined to form the second bit-sequence in part or in entirety.

In the method of bit-sequence transmission of the present invention, the first bit-sequence has a given number of bits, the lead-bit of the second bit-sequence corresponds to the start-bit for asynchronous communication, and bits corresponding to the stop-bit for asynchronous communication are stored in bit locations that follow the bit locations storing the second bit-sequence in the register.

The battery pack of the present invention is provided with a rechargeable battery, a communication control section that controls communication with external electrical equipment that can charge and discharge the rechargeable battery, and an authentication section that performs battery pack authentication with the electrical equipment. The battery pack is characterized by providing a serial communication line connecting the communication control section and the authentication section, and the authentication section exchanges authentication signals with the electrical equipment via the serial communication line and the communication control section.

In the battery pack of the present invention, the communication control section is provided with a register; a converting unit to convert the first bit-sequence transmitted by the encoding scheme, which transmits zeros and ones with different pulse widths, to the second bit-sequence to be transmitted by NRZ encoding; a storing unit to store the second bit-sequence converted by the converting unit in a register; a timing unit to repeatedly time pulse widths to transmit zeros and ones by NRZ encoding; and a transmitting unit to change the (voltage) level for serial communication line transmission according to changes in the value of each bit read sequentially from the second bit-sequence stored in the register during timing by the timing unit.

In the battery pack of the present invention, the storing unit stores the second bit-sequence, which was converted by the converting unit, in the register in a manner that makes the lead-bit the MSB (or LSB); when the timing unit begins timing for transmission, the transmitting unit changes the level transmitted by the serial communication line depending on the value of the MSB (or LSB) stored in the register; and a unit is provided to shift the register left (or right) by one bit after the transmitting unit has changed the transmission level.

In the battery pack of the present invention, a memory unit is provided that stores each of a plurality of bit-sequences having a given number of bits to be transmitted by the encoding scheme, and stores corresponding bit-sequences converted for transmission by NRZ encoding with links to each unconverted bit-sequence. When the number of bits in the first bit-sequence exceeds the given number of bits, the converting unit segments the first bit-sequence into bit-sequences having the given number of bits. Bit-sequences stored in the memory unit and linked to each segmented bit-sequence are read-out, and the read-out bit-sequences are joined to form the second bit-sequence in part or in entirety.

In the battery pack of the present invention, the first bit-sequence has a given number of bits, the lead-bit of the second bit-sequence corresponds to the start-bit for asynchronous communication, and a unit is provided to store bits corresponding to the stop-bit for asynchronous communication in bit locations that follow the bit locations storing the second bit-sequence in the register.

In the present invention, the authentication section and electrical equipment exchange authentication signals via the communication control section and a serial communication line established between the authentication section and the communication control section. Consequently, signals exchanged between the communication control section and electrical equipment include signals related to authentication. Specifically, since there is no direct exchange of signals between the battery pack authentication section and electrical equipment, the number of signal lines in the battery pack and between the battery pack and electrical equipment can be reduced by that amount.

In the present invention, the first bit-sequence to be transmitted from the communication control section to the authentication section according to the encoding scheme that transmits zeros and ones with different pulse widths is converted to the second bit-sequence to be transmitted according to NRZ encoding with equal pulse widths, and the converted second bit-sequence is stored in the register. Further, when repeatedly timing pulse widths to transmit zeros and ones by NRZ encoding, the transmission (voltage) level of the signal output to the authentication section is made a HIGH level or a LOW level (reversed levels for negative logic) depending on whether the bit value of the sequentially read second bit-sequence stored in the register is a one or zero respectively. As a result, the pulse waveform on the serial communication line when the second bit-sequence is transmitted by NRZ encoding is identical to the pulse waveform on the serial communication line when the first bit-sequence is transmitted by the encoding scheme specific to the authentication section.

In the present invention, the MSB (or LSB) of the converted second bit-sequence and the MSB (or LSB) of the register that stores the second bit-sequence are arranged to correspond. When timing for transmission is started, the (voltage) level output to the authentication section by the serial communication line is made HIGH or LOW (reversed levels for negative logic) depending on whether a one or zero is stored in the MSB (or LSB) of the register. Subsequently the register is shifted left (or right) by one bit. Since the pulses that transmit each bit of the second bit-sequence have equal widths, the register holding the second bit-sequence is shifted one bit at a time with equal time intervals. Accordingly, the second bit-sequence can be transmitted to the authentication section simply by loading the value of the bit stored in the MSB (or LSB) prior to each shift operation into the register that sets the serial communication line output level.

In the present invention, each one of a plurality of bit-sequences having a given number of bits and anticipated for transmission by the encoding scheme is converted to a bit-sequence to be transmitted by NRZ encoding, and each converted bit-sequence is stored in memory with a link to the pre-conversion bit-sequence. When the number of bits in the first bit-sequence to be transmitted to the authentication section by the encoding scheme exceeds the given number of bits, the first bit-sequence is segmented into bit-sequences having the given number of bits. Bit-sequences stored in memory and linked to each segmented bit-sequence are read-out, and the read-out bit-sequences are joined to form the second bit-sequence in part or in entirety. A bit or bit-sequence remaining in a first bit-sequence without being segmented into the given number of bits is, for example, converted bit by bit and joined as another part of the second bit-sequence. As a result, even when there is a large number of bits in the first bit-sequence, conversion to the second bit-sequence can be performed rapidly and straightforwardly by grouping a given number bits together, converting the groups, and joining them together.

In the present invention, the first bit-sequence has a given number of bits and is transmitted by an encoding scheme that is equivalent to making the lead-bit of the second bit-sequence, which is converted from the first bit-sequence, correspond to the start-bit for asynchronous communication. Further, after storing the second bit-sequence in the register, stop-bits are added at the end of the stored second bit-sequence. Since transmission of the second bit-sequence in accordance with asynchronous communication standards is performed after the leading start-bit, the second bit-sequence, and the stop-bits are completely stored in the register, processing tasks to transmit the second bit-sequence by asynchronous communication standards are reduced.

In the present invention, the authentication section and electrical equipment exchange authentication signals via communication between the communication control section and electrical equipment. As a result, it is possible to reduce the number of signal lines connected in a battery pack having authentication capability. The above and further objects of the present invention as well as the features thereof will become more apparent from the following detailed description to be made in conjunction with the accompanying drawings.

### BRIEF DESCRIPTION OF THE DRAWINGS

FIG. 1 is a block diagram showing an example of the structure of a battery pack for an embodiment of the present invention;

FIG. 2 is a flow-chart showing control and power source section, and authentication chip processing steps for battery pack authentication;

FIG. 3A is a diagram illustrating an example of a pulse-sequence encoded according to the transmission encoding scheme specified for the authentication chip, B is a diagram showing the first bit-sequence that is transmitted by the pulse-sequence shown in diagram A according to the encoding scheme, C is a diagram showing the second bit-sequence that is transmitted when the pulse-sequence shown in diagram A is assumed to be NRZ encoded;

FIG. 4 is a table showing examples of converting four sequential data bits included in the first bit-sequence to part of the second bit-sequence;

FIG. 5 is a flow-chart showing central processing unit (CPU) processing steps to convert the first bit-sequence to the second bit-sequence in a battery pack of the present invention; and

FIG. 6 is a flow-chart showing CPU processing steps to transmit converted second bit-sequence data to the authentication chip.

### DETAILED DESCRIPTION OF THE EMBODIMENT(S)

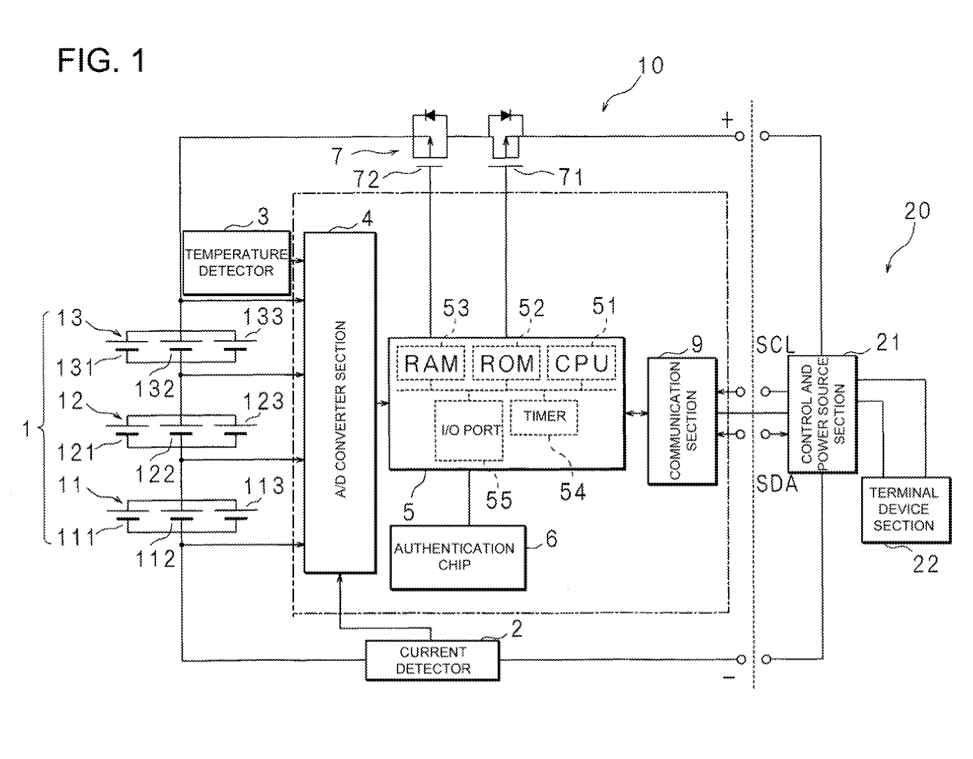

The following describes embodiments of the present invention based on the figures. FIG. 1 is a block diagram showing an example of battery pack structure for an embodiment of the present invention. The battery pack 10 of the figure attaches in a detachable manner to electrical equipment 20 such as a personal computer (PC) or other portable terminal device. The battery pack 10 is provided with a rechargeable battery 1 made up of lithium ion battery cells 111, 112, 113, 121, 122, 123, 131, 132, 133 connected in parallel and in numerical order in three groups as battery blocks 11, 12, 13, which are in-turn connected in series. The positive electrode of the battery block 13 and the negative electrode of the battery block 11 become the positive and negative electrode terminals of the rechargeable battery 1.

The voltage of each battery block 11, 12, 13 is independently input to an analog input terminal of an analog-to-digital (A/D) converter section 4, and converted to a digital value that is output to a microcomputer control section 5 from the A/D converter section 4 digital output terminal. Output from a temperature detector 3 disposed in thermal connection with the rechargeable battery 1 to detect rechargeable battery 1 temperature via circuitry including a thermistor, and output from a current detector 2 that is a resistor connected in the charging and discharging circuit path on the negative electrode terminal-side of the rechargeable battery 1 to detect charging and discharging current are also input to A/D converter section 4 analog input terminals. These detected values are also converted to digital values that are output to the control section 5 from the ND converter section 4 digital output terminal.

Cut-off devices 7, which are P-channel metal-oxide-semiconductor field-effect transistors (MOSFETs) 71, 72, are connected in the charging and discharging path on the positive electrode terminal-side of the rechargeable battery 1 to cut-off charging and discharging current. The MOSFETs 71, 72 are connected in series with their drains connected at a common node. The diode connected between the source and drain in parallel with each MOSFET 71, 72 is the parasitic (drain-body) diode.

The control section 5 has a CPU 51. The CPU 51 is connected through a bus with read-only memory (ROM) 52 that stores information such as programs, random access memory (RAM) 53 that temporarily stores generated data, a timer 54 for time measurements, and input-output (I/O) ports 55 for communication with each section in the battery pack 10. I/O ports 55 are connected with the A/D converter section 4 digital output terminal, the gate of each MOSFET 71, 72, the communication section 9 that communicates with the control and power source section 21 in the electrical equipment 20, and the authentication chip 6 that performs battery pack authentication with the electrical equipment 20. The authentication chip 6 and an I/O port 55 are connected via a serial communication line. The ROM 52 is non-volatile memory such as electrically erasable programmable read-only memory (EEPROM) or flash memory. Besides operating programs the ROM 52 stores self-modifying battery capacity values, the charging and discharging cycle count, voltage settings, current settings, and various other set data.

The CPU 51 performs functions such as arithmetic operations and input-output operations according to a control program pre-stored in ROM 52. For example, the CPU 51 reads-in battery block 11, 12, 13 voltages and the detected charging and discharging current value with a 250 ms periodicity, integrates the remaining capacity of the rechargeable battery 1 based on the acquired voltage and detection values, and stores the results in RAM 53. The CPU 51 also generates remaining capacity data that are written to a register (not illustrated) in the communication section 9, where that remaining capacity data are output.

During normal charging and discharging, LOW level ON signals from the I/O ports 55 are applied to the gates of the cut-off device 7 (P-channel) MOSFETs 71, 72 to enable conduction between the source and drain of each MOSFET 71, 72. In the case of rechargeable battery 1 charging current cut-off, a HIGH level OFF signal is sent from an I/O port 55 to the gate of MOSFET 71 to cut-off source-to-drain conduction. Similarly, for rechargeable battery 1 discharging current cut-off, a HIGH level OFF signal is sent from an I/O port 55 to the gate of MOSFET 72 to cut-off source-to-drain conduction. When the rechargeable battery 1 is appropriately charged, both cut-off device 7 MOSFETs 71, 72 are turned ON in a state that allows rechargeable battery 1 charging and discharging.

The electrical equipment 20 is provided with a terminal device section 22 connected to a control and power source section 21. Although not illustrated, the control and power source section 21 supplies power from a commercial power source to operate the terminal device section 22 and supply charging current to the rechargeable battery 1 charging and discharging circuit.

In addition, when power is not supplied from the commercial power source, the control and power source section 21 operates the terminal device section 22 with discharging current supplied from the rechargeable battery 1 charging and discharging circuit. When the rechargeable battery 1 is made up of lithium ion batteries, the control and power source section 21 performs constant current-constant voltage charging while regulating maximum current (for example, to approximately 0.5 to 1C) and maximum voltage (for example, to approximately 4.2V/cell to 4.4V/cell). When rechargeable battery 1 terminal voltage becomes a set voltage or greater and charging current becomes a set current or lower, full-charge is determined.

Communication between the control and power source section 21 and the communication section 9 is implemented according to a standard such as System Management Bus (SMBus) protocol with the control and power source section 21 as the master and the communication section 9 as the slave. Here, the serial clock (SCL) is supplied by the control and power source section 21, and serial data (SDA) is transmitted in both directions between the control and power source section 21 and the communication section 9. In the present embodiment, the control and power source section 21 polls the communication section 9 with a 2 sec period and reads-in the contents of the communication section 9 register. For example, this polling transfers rechargeable battery 1 remaining capacity data from the communication section 9 to the control and power source section 21 every 2 sec, and the remaining capacity value is indicated as a percentage by a display (not illustrated) in the electrical equipment 20. The 2 sec polling period described above is a value set by the control and power source section 21.

The authentication chip 6 communicates with the control and power source section 21 in the electrical equipment 20 for battery pack 10 authentication through an I/O port 55 of the control section 5 and the communication section 9. Battery pack authentication is attempted by the control and power source section 21, which acts as the primary controller. At that time, authentication data passed between the authentication chip 6 and the I/O port 55 is divided into bit-sequences with a given number of bits (for example, 13 bits), and the bit-sequences are sequentially transmitted according to the encoding scheme specified for the authentication chip 6. In contrast, authentication data is exchanged between the control section 5 and the control and power source section 21 by the same method described previously for remaining capacity data transmission.

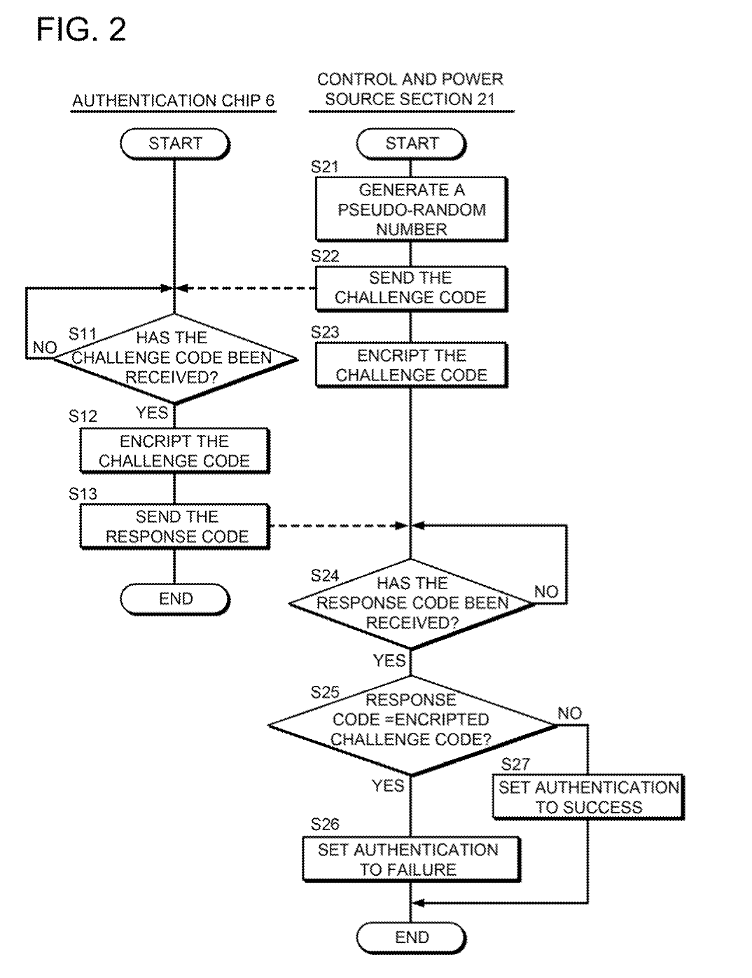

The following describes battery pack 10 authentication. FIG. 2 is a flow-chart showing control and power source section 21 and authentication chip 6 processing steps for battery pack 10 authentication. A common encryption key is pre-stored in the control and power source section 21 and in the authentication chip 6. Processing shown in FIG. 2 is performed by microcomputers (not illustrated) embedded in both the control and power source section 21 and the authentication chip 6. At the time of battery pack 10 attachment to the electrical equipment 20, voltage change is detected on a battery-connect terminal (not illustrated) by the control and power source section 21, and that voltage change initiates authentication processing by the control and power source section 21. Processing on the battery pack 10 side is initiated as required.

Processing for authentication proceeds by sending a challenge code from the control and power source section 21 to the control section 5 (communication control section), and sending a response code from the control section 5 (communication control section) to the control and power source section 21. At that time, the challenge code is sent from the control section 5 (communication control section) to the authentication chip 6, and the response code is sent from the authentication chip 6 to the control section 5 (communication control section). Since the codes are binary numbers, they are exchanged between the control and power source section 21 and the control section 5 (communication control section) by a communication standard such as the previously described SMBus protocol. Communication between the authentication chip 6 and the control section 5 (communication control section) is described below.

First, the control and power source section 21 generates a pseudo-random number (S21), and that pseudo-random number is sent as the challenge code to the authentication chip 6 through the control section 5 (communication control section) (S22). Next, the control and power source section 21 encrypts the transmitted challenge code with the common encryption key (S23), and stores it in memory (not illustrated). Subsequently, the control and power source section 21 determines whether or not the response code has been received from the authentication chip 6 through the control section 5 (communication control section) (S24), and stands-by until that response code has been received (S24: NO).

Meanwhile, the authentication chip 6 determines whether or not the challenge code has been received (S11), and stands-by until the challenge code has been received (S11: NO). When the challenge code has been received (S11: YES), the authentication chip 6 encrypts the received challenge code with the common encryption key (S12), sends the encrypted challenge code as the response code to the control and power source section 21 through the control section 5 (communication control section) (S13), and ends its FIG. 2 processing.

On the other side, if the control and power source section 21 has received the response code (S24: YES), it determines whether or not the received response code is equivalent to the encrypted challenge code stored in memory (S25). If the response code and encrypted challenge code are the same (S25: YES), memory is set to indicate successful authentication (S26), and FIG. 2 processing is ended. If the response code and encrypted challenge code are not the same (S25: NO), the control and power source section 21 sets memory to indicate authentication failure (S27), and ends FIG. 2 processing.

In the case of successful authentication, the control and power source section 21 performs battery pack 10 charging and discharging in the normal manner. In the case of authentication failure, the control and power source section 21 does not charge or discharge the battery pack 10, and transmits notice of authentication failure to the terminal device section 22 to display a warning indication.

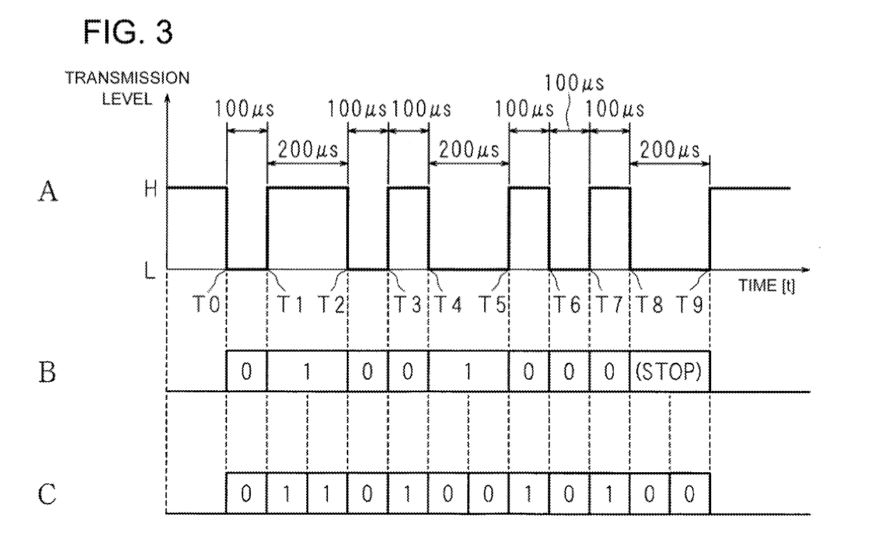

The following describes pulse-sequences encoded according to the encoding scheme and bit-sequences transmitted by the pulse-sequences. FIG. 3A is a diagram illustrating an example of a pulse-sequence encoded according to the transmission encoding scheme specified for the authentication chip, B is a diagram showing the first bit-sequence that is transmitted by the pulse-sequence shown in diagram A according to the encoding scheme (this first bit-sequence is an example of one of the transmitted and received codes described above), and C is a diagram showing the second bit-sequence that is transmitted when the pulse-sequence shown in diagram A is assumed to be NRZ encoded. Said differently, the pulse-sequence encoded according to the encoding scheme specified for the authentication chip 6 and shown in FIG. 3A can be generated by the sequence of zeros and ones in the signal of FIG. 3C. The vertical axis of FIG. 3A shows the transmission (voltage) level (HIGH level or LOW level), and the horizontal axis indicates time (t).

As a transmission encoding scheme specified for the authentication chip 6, pulses are encoded in accordance with the following rules, which are based on specification standards for asynchronous communication. However, the transmission encoding scheme used for communication between the authentication chip 6 and the I/O port 55 is not limited to this encoding scheme.

(a) The length of a bit-sequence sent at one time is 13 bits. However, for simplicity, the length of the bit-sequence shown in FIG. 3 is 8 bits.
(b) The pulse transmission level is inverted for each bit transmitted. Specifically, the transmission level is reversed (from HIGH to LOW or LOW to HIGH) for each zero (0) or one (1) transmitted.
(c) The pulse width for transmitting a one (1) is twice the pulse width for transmitting a zero (0). (This pulse width multiple could also be three times or greater.)
(d) The transmission level for the start-bit and stop-bit is inverted from the idle-state level when no bit-sequences are being transmitted.
(e) The pulse for the lead-bit of a bit-sequence serves as the start-bit.
(f) The pulse width of the stop-bit is the same as the pulse width for data representing a one (1).

As a specific example, transmission of the first bit-sequence (01001000) shown in FIG. 3B is described one bit at a time starting at the MSB. Since the idle-state level is a HIGH (voltage) level, the bit from time T0 to time T1 (FIG. 3A), which is a LOW transmission level, becomes the start-bit. Accordingly, data for the MSB of the first bit-sequence (regardless of whether it is a zero [0] or a one [1]) is always transmitted as a LOW level. In the present embodiment, the time from T0 to T1 is 100 μsec.

Next, the transmission level is inverted to a HIGH level at time T1 when transmission of data (1) for the second most significant bit of the first bit-sequence is started. This HIGH level is maintained for 200 μsec until time T2. At time T2, the transmission level is inverted to a LOW level to start transmitting data (0) for the third bit. After 100 μsec at time T3, the transmission level is inverted to a HIGH level to start transmitting data (0) for the fourth bit.

100 μsec after time T3 at time T4, the transmission level is inverted to a LOW level to start transmitting data (1) for the fifth bit, and this LOW level is maintained for 200 μsec until time T5. At time T5, the transmission level is inverted to a HIGH level to start transmitting data (0) for the sixth bit. After 100 μsec at time T6, the transmission level is inverted to a LOW level to start transmitting data (0) for the seventh bit.

100 μsec after time T6 at time T7, the transmission level is inverted to a HIGH level to start transmitting data (0) for the eighth bit, and after 100 μsec at time T8, the transmission level is inverted to a LOW level to start transmitting the stop-bit. The stop-bit is maintained for 200 μsec, and the transmission level is returned to the HIGH level idle-state at time T9. In the case shown in FIG. 3 where the number of bits in the first bit-sequence is 8 bits, LSB data is always transmitted as a HIGH level because MSB data is always sent as a LOW level (inverted from the idle-state). However, since the first bit-sequence is actually 13 bits, LSB data is always transmitted as a LOW level.

When the pulse-sequence shown in FIG. 3A and encoded as described above is instead assumed to be encoded by NRZ encoding, the bit-sequence transmitted by the pulse-sequence in FIG. 3A becomes the second bit-sequence (0110100101) of FIG. 3C, which is converted from the first bit-sequence of FIG. 3B. Here, data bits included in the first bit-sequence that have a value of one (1) are converted to two bits of data in the second bit-sequence. Said differently, the pulse-sequence shown in FIG. 3A can be obtained by NRZ encoding the data of the second bit-sequence, which is converted from the first bit-sequence. Specifically, the control section 5 (communication control section) receives the challenge code as the first bit-sequence, generates the pulse-sequence shown in FIG. 3A from the corresponding second bit-sequence, and transmits that pulse-sequence to the authentication chip 6. Further, a pulse-sequence similar to that of FIG. 3A is transmitted as the response code from the authentication chip 6 to the control section 5 (communication control section). Finally, that pulse-sequence is converted to a first bit-sequence that is transmitted from the control section 5 (communication control section) to the control and power source section 21.

Since the pulse that transmits the stop-bit in the present embodiment is always a LOW level and has a width of 200 μsec, data representing the stop-bit is replaced by two zero data bits (00) following the second bit-sequence. However, if a stop-bit is not used in the encoding scheme specified for the authentication chip 6, data following the second bit-sequence can be, for example, a one (1) or ones (11) to transmit stop-bit(s) of (1) or (11) when the pulse-sequence is viewed as an NRZ encoded sequence.

Serial communication line (voltage) levels for transmission from the control section 5 to the authentication chip 6 are determined by writing data to the I/O port 55 output register. Here, the second bit-sequence converted from the first bit-sequence and followed by two zero data bits (00) is previously stored in a general-purpose register (not illustrated) in the CPU 51. Processing to transmit the second bit-sequence by NRZ encoding pulses as shown in FIG. 3A in accordance with asynchronous communication standards entails writing the data stored in the general-purpose register sequentially from the MSB, one bit at a time at 100 μsec intervals to the output register. Since the lead-bit of the second bit-sequence corresponds to the start-bit and stop-bits follow the second bit-sequence stored in the general-purpose register, processing proceeds without having to distinguish the start-bit and stop-bits. It should be noted that a register to store the second bit-sequence can be selected such as 16 bit or 32 bit, depending on required bit number. Also, a plurality of registers can be employed to increase bit number.

The authentication chip 6 receives the pulse-sequence shown in FIG. 3A, and since the lead-pulse that transmits the start-bit has a pulse width of 100 μsec, lead-bit data is received as a zero (0) by the pulse transmitted the same as a start-bit. Subsequently, since 7 bits of data (12 bits in actuality) are sequentially received and followed by a pulse corresponding to the stop-bit, the stop-bit is not is not received as data with a value of one (1).

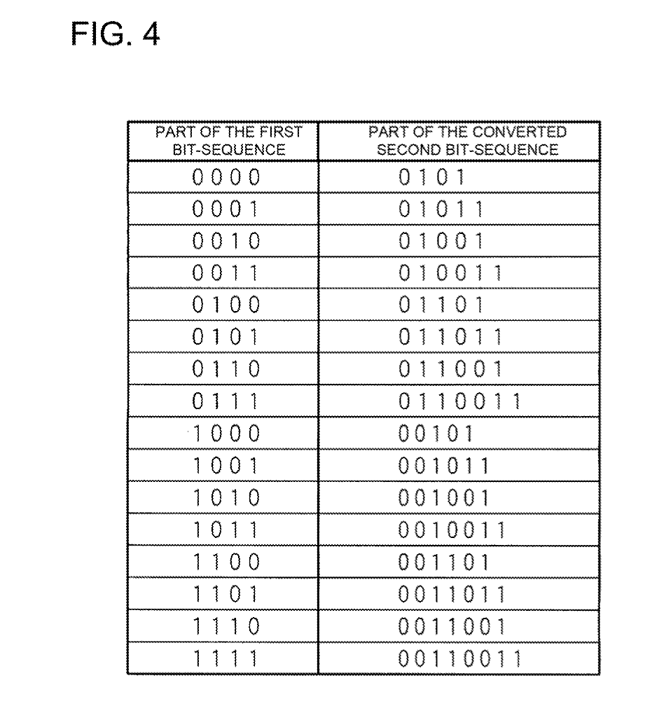

The following describes a method of grouping together a given number of bits in the first bit-sequence and converting them to bits in the second bit-sequence. FIG. 4 is a table showing examples of converting four sequential data bits included in the first bit-sequence to part of the second bit-sequence. In FIG. 4, data shown at the left-most side of a binary number is transmitted first. Since four bits of binary data can have sixteen different values, FIG. 4 shows examples of conversion of all sixteen values. Each first bit-sequence segment shown in FIG. 4 is converted to part of a second bit-sequence according to specification rules (b) and (c) described previously. Each converted second bit-sequence segment is stored in RAM 53 with a link to the pre-conversion first bit-sequence segment.

As described previously, since the lead-bit of the first bit-sequence is always transmitted as a LOW level, the lead-bit of the converted second bit-sequence is always (0). Further, since the transmission level inverts each time a bit in the first bit-sequence is encoded as a pulse, the last bit in the converted second bit-sequence segment is always (1) when the lead 4 bits of the first bit-sequence are converted. These conversion results are the same when the fifth bit to the eighth bit of the first bit-sequence is converted to part of a second bit-sequence. By using this type of conversion table to successively convert first bit-sequences to parts of second bit-sequences, the conversion processing burden is reduced.

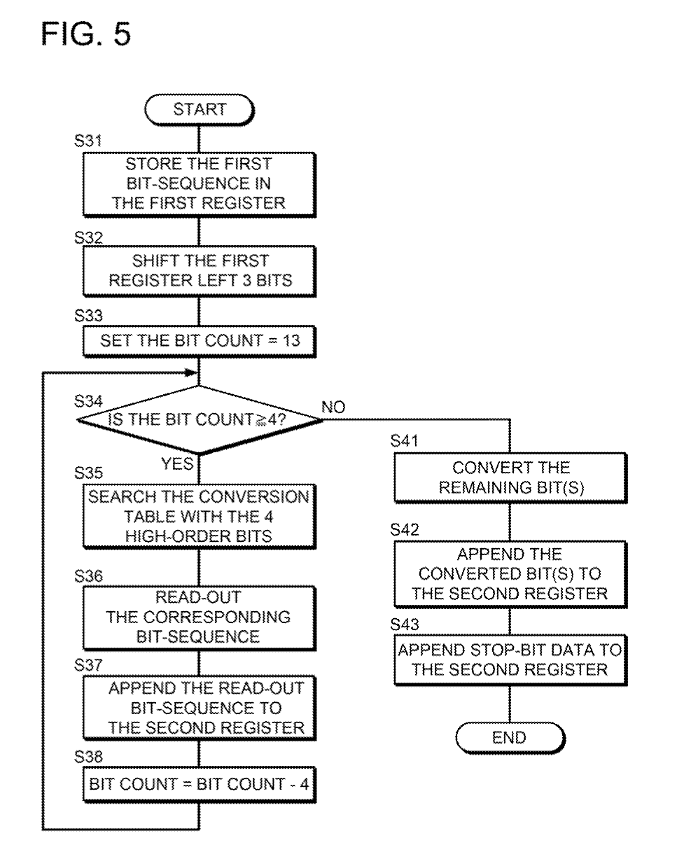

The following describes operation of the battery pack 10 control section 5 using a flow-chart. Processing described below is performed by the CPU 51 according to a control program pre-stored in ROM 52. FIG. 5 is a flow-chart showing CPU 51 processing steps to convert the first bit-sequence to the second bit-sequence in a battery pack of the present invention. Processing in FIG. 5 is activated when data is generated for transmission from the control section 5 to the authentication chip 6 and that data is divided into first bit-sequences having 13 bits. When the number of bits is less than 13 bits, data can be converted 4 bits at a time using the conversion table the same as in FIG. 5, and the remaining unconverted one to three bits can be converted one bit at a time or they can be converted using a conversion table for converting short bit-sequences.

When FIG. 5 processing is activated, the CPU 51 stores the first bit-sequence in a first register in the CPU 51 (S31), and subsequently shifts that first register left 3 bits (S32). This positions the MSB of the 13 bit first bit-sequence coincident with the MSB of the first register (16 bit register). Next, the CPU 51 writes a value of 13 into the bit count stored in RAM 53 (S33).

Subsequently, the CPU 51 judges whether or not the value of the bit count stored in RAM 53 is greater than or equal to 4 (S34). If the bit count is 4 or greater (S34: YES), the CPU 51 searches the table shown in FIG. 4 using the 4 high-order bits in the first register (S35). Next, the CPU 51 reads-out the corresponding partial second bit-sequence stored in RAM 53 and linked to the 4 bits that were searched (S36). The read-out bit-sequence is then appended in a left-justified manner (from the MSB) to the contents of a second register (concatenated with the contents of the second register) included in the CPU 51 (S37). When the bit-sequence is appended, a corresponding running count of the number of bits stored is also incremented and saved. Subsequently, the CPU 51 decrements the bit count stored in RAM 53 by 4 (S38), and processing returns to step S34.

If the bit count in step S34 is not greater than or equal to 4 (S34: NO), the CPU 51 converts the remaining bit(s) (in this case, the single LSB bit) according to the specification rules (b) and (c) described previously (S41) and appends the converted bit(s) (bit-sequence for a plurality of remaining bits) to the second register (S42). Finally, the CPU 51 appends stop-bit data (00) to the second register (S43) and ends FIG. 5 processing.

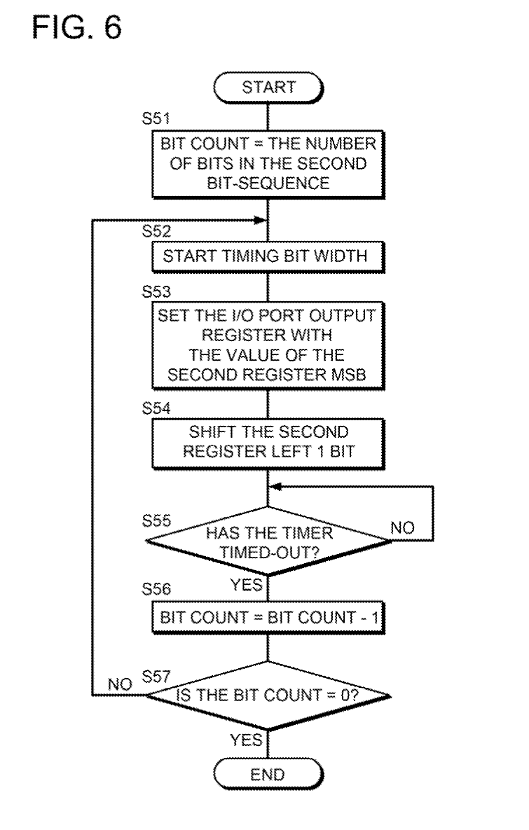

The following describes transmission of the contents of the second register. FIG. 6 is a flow-chart showing CPU 51 processing steps to transmit converted second bit-sequence data to the authentication chip 6. Processing in FIG. 6 is activated when FIG. 5 processing is completed.

When FIG. 6 processing is activated, the CPU 51 writes the running count of the number of bits appended to the second bit-sequence into the RAM 53 location that stores the bit count (S51). Subsequently, the CPU 51 starts timing bit width with the timer 54 according to the BAUD (Baudot Code) rate for the asynchronous communication standard (S52). Next, the CPU 51 sets the I/O port 55 output register, which determines the serial communication line transmission level, to the value (0 or 1) of the data stored in the MSB of the second register (S53), and then shifts the second register left 1 bit (S54).

Subsequently, the CPU 51 judges whether or not the timer 54 has timed-out (S55) and stands-by until timing is complete (S55: NO). If the timer 54 has timed-out (S55: YES), the CPU 51 decrements the bit count stored in RAM 53 by 1 (S56), and judges whether or not the bit count has become 0 (S57). If the bit count has not become 0 (S57: NO), CPU 51 processing returns to step S52. On the other hand, if the bit count has become 0 (S57: YES), the CPU 51 ends FIG. 6 processing.

In accordance with the present embodiment described above, the authentication chip and electrical equipment exchange authentication signals via the control section and the serial communication line established between the authentication chip and the control section. Consequently, authentication signals are included in the signals exchanged between the control section and the electrical equipment. As a result it is possible to reduce the number of signal lines connected in a battery pack that has authentication capability.

The first bit-sequence, which is to be transmitted from the control section to the authentication chip according to the encoding scheme that transmits each one (1) and zero (0) by a pulse with a width of 200 μsec and 100 μsec respectively, is converted to the second bit-sequence to be transmitted according to NRZ encoding with equal pulse widths, and that second bit-sequence is stored in the second register. Timing to set the pulse width for transmission of a one (1) or zero (0) by NRZ encoding is performed repeatedly, and during each timed interval, the signal transmission level output to the authentication chip is made a HIGH level or a LOW level depending on whether the value of each different bit sequentially taken from the second bit-sequence stored in the second register is a one (1) or zero (0). As a result, it is possible to make the pulse waveform on the serial communication line when the second bit-sequence is transmitted by NRZ encoding identical to the pulse waveform on the serial communication line when the first bit-sequence is transmitted by the encoding scheme specific to the authentication chip.

The position of the MSB of the converted second bit-sequence is made to align with the MSB of the second register that stores the second bit-sequence. At the start of each timed interval, the transmission level of the signal output to the authentication chip is made HIGH or LOW depending on whether the value of the second register MSB is a one (1) or a zero (0) respectively. Subsequently, the second register is shifted left 1 bit. As a result, since the pulse width to transmit each bit of the second bit-sequence is a constant 100 μsec, the second register that holds the second bit-sequence is sequentially shifted at 100 μsec intervals. Further, by simply setting the I/O port output register, which determines the serial communication line output (voltage) level, to the value of the MSB of the second register prior to each shift operation, the second bit-sequence can be transmitted to the authentication chip.

Each of a plurality of 4 bit bit-sequences anticipated for transmission according to the encoding scheme specific to the authentication chip are converted to bit-sequences for transmission according to NRZ encoding, and each pre-conversion bit-sequence and post-conversion bit-sequence is stored and linked in RAM. When the number of bits in the first bit-sequence to be transmitted to the authentication chip according to the chip-specific encoding scheme is greater than 4 bits, the first bit-sequence is segmented into bit-sequences having a length of 4 bits. Each bit-sequence linked in RAM to a segmented bit-sequence is read-out, and each read-out bit-sequence is appended to the second register as a part of the second bit-sequence. A bit or bit-sequence left over after the first bit-sequence is divided into 4 bit segments is converted bit by bit and appended to the second register. As a result, when the number of bits in the first bit-sequence is greater than 4, bit-sequences are converted 4 bits at a time referring to a table and the converted bit-sequences are joined together. This makes rapid and straightforward conversion to the second bit-sequence possible.

The first bit-sequence is transmitted by an encoding scheme that corresponds to making the lead-bit of the second bit-sequence the start-bit for asynchronous communication when the second bit-sequence is converted from the first bit-sequence having a given number of bits such as 8 bits or 13 bits. Further, after the second bit-sequence is stored in the second register, stop-bit data (00) is appended to the end of the stored second bit-sequence. As a result, transmission of the second bit-sequence in accordance with asynchronous communication standards begins only after the second bit-sequence with a lead-bit corresponding to the start-bit and appended stop-bits have been completely stored in the second register. Therefore, it is possible to reduce the burden for transmitting the second bit-sequence in accordance with asynchronous communication standards.

In the present embodiment, the MSB of the second bit-sequence converted from the first bit-sequence is made to coincide with the MSB of the second register that stores the second bit-sequence. However, the present invention is not limited to that method, and it is also possible to store the MSB followed by each bit of the second bit-sequence right-justified to the LSB of the second register. In that case, at the start of timing the width of each pulse, the bit value stored in the LSB position of the second register is loaded into the I/O port 55 output register and the second register is subsequently shifted right 1 bit.

In the present embodiment, although the value of the MSB of the second register, which stores the second bit-sequence, is loaded into the I/O port 55 output register prior to left shifting the second register, the present invention is not limited to that procedure. For example, it is also possible to shift the second register left and then load the value of the bit shifted out of the second register into the I/O port 55 output register.

In the present embodiment, when data is transmitted from the control section 5 to the authentication chip 6 in accordance with asynchronous communication standards, the idle-state transmission level is assumed HIGH and the start-bit and stop-bits are LOW levels. However, the present invention is not limited to that arrangement, and the idle-state level could also be LOW and data transmitted with HIGH level start and stop-bits.

The present embodiment describes conversion of the first bit-sequence to the second bit-sequence followed by transmission of NRZ encoded pulses from the control section 5 to the authentication chip 6. Conversely, when bit-sequences from the authentication chip 6 are transmitted to the control section 5, sufficient input buffer space is allocated in the control section 5 and pulses transmitted from the authentication chip 6 are treated as NRZ encoded pulse-sequences. After receiving all the bit-sequences in a signal, the bit-sequences in the input buffers are interpreted as second bit-sequences and can be converted in reverse to first bit-sequences. In this case as well, the conversion table shown in FIG. 4 can be used.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2011-127469 filed in Japan on Jun. 7, 2011, the content of which is incorporated herein by reference.

What is claimed is:

1. A method of signal exchange between an authentication section and external electrical equipment for authentication of a battery pack provided with a rechargeable battery, a communication control section that controls communication with electrical equipment that can charge and discharge the rechargeable battery, and an authentication section that performs battery pack authentication with the electrical equipment, the method comprising:
providing a serial communication line between the authentication section and the communication control section; and
exchanging signals via the serial communication line and the communication control section.

2. A method of bit-sequence transmission that transmits a first bit-sequence to the authentication section using the method of signal exchange recited in claim 1 in accordance with an encoding scheme that transmits zeros and ones via the communication control section with different pulse widths, the method comprising:
providing a register;
converting the first bit-sequence to a second bit-sequence to be transmitted by non-return-to-zero (NRZ) encoding;
storing the converted second bit-sequence in the register;
repeating time pulse widths to transmit zeros and ones by NRZ encoding; and
changing the serial communication line transmission level according to changes in the value of each bit read sequentially from the second bit-sequence stored in the register.

3. The method of bit-sequence transmission as cited in claim 2 wherein the converted second bit-sequence is stored in the register in a manner that makes the lead-bit the MSB or LSB of the register;
when timing for transmission is started, the level transmitted by the serial communication line is changed depending on the value of the MSB or LSB stored in the register; and
subsequently the register is shifted left (or right) by one bit.

4. The method of bit-sequence transmission as cited in claim 2 further comprising:
provided a memory,
wherein each one of a plurality of bit-sequences having a given number of bits to be transmitted by the encoding scheme is converted to a bit-sequence to be transmitted by NRZ encoding;
each of the plurality of bit-sequences and corresponding converted bit-sequences are stored and linked in memory;
when the number of bits in the first bit-sequence exceeds the given number of bits, the first bit-sequence is segmented into bit-sequences having the given number of bits;
bit-sequences stored in memory and linked to each segmented bit-sequence are read-out; and
the read-out bit-sequences are joined to form the second bit-sequence in part or in entirety.

5. The method of bit-sequence transmission as cited in claim 2 wherein the first bit-sequence has a given number of bits;
the lead-bit of the second bit-sequence corresponds to the start-bit for asynchronous communication; and
bits corresponding to the stop-bit for asynchronous communication are stored in bit locations that follow the bit locations storing the second bit-sequence in the register.

6. A battery pack comprising:
a rechargeable battery;
a communication control section that controls communication with external electrical equipment that can charge and discharge the rechargeable battery;
an authentication section that performs battery pack authentication with the electrical equipment; and
a serial communication line that connects the communication control section and the authentication section,
wherein the authentication section exchanges authentication signals with the electrical equipment via the serial communication line and the communication control section.

7. The battery pack as cited in claim 6 wherein the communication control section comprises:
a register;
a converting unit to convert the first bit-sequence transmitted by the encoding scheme, which transmits zeros and ones with different pulse widths, to the second bit-sequence to be transmitted by NRZ encoding;
a storing unit to store the second bit-sequence converted by the converting unit in a register;
a timing unit to repeatedly time pulse widths to transmit zeros and ones by NRZ encoding; and
a transmitting unit to change the level for serial communication line transmission at timing unit time intervals according to changes in the value of each bit read sequentially from the second bit-sequence stored in the register.

8. The battery pack as cited in claim 7 wherein the storing unit stores the second bit-sequence converted by the converting unit in the register in a manner that makes the lead-bit the MSB or LSB;
when the timing unit begins timing for transmission, the transmitting unit changes the level transmitted by the serial communication line depending on the value of the MSB or LSB stored in the register; and
a unit is provided to shift the register left or right by one bit after the transmitting unit has established the transmission level.

9. The battery pack as cited in claim 7 wherein a memory unit is provided that stores each of a plurality of bit-sequences having a given number of bits to be transmitted by the encoding scheme, and stores corresponding bit-sequences converted for transmission by NRZ encoding with links to each unconverted bit-sequence;
when the number of bits in the first bit-sequence exceeds the given number of bits, the converting unit segments the first bit-sequence into bit-sequences having the given number of bits; bit-sequences stored in the memory unit and linked to each segmented bit-sequence are read-out, and the read-out bit-sequences are joined to form the second bit-sequence in part or in entirety.

10. The battery pack as cited in claim 7 wherein the first bit-sequence has a given number of bits;
the lead-bit of the second bit-sequence corresponds to the start-bit for asynchronous communication;
and a unit is provided to store bits corresponding to the stop-bit for asynchronous communication in bit locations that follow the bit locations storing the second bit-sequence in the register.
